(19) United States
(12) Patent Application Publication
(10) Pub. No.: US 2007/0023150 A1
(43) Pub. Date: Feb. 1, 2007

(54) Convertible window covering

(76) Inventors: Fu-Lai Yu, Taipei Hsieh (TW); Chin-Tien Huang, Taipei Hsieh (TW); Shun-Chi Yu, Taipei Hsieh (TW)

Correspondence Address: OLSON & HIERL, LTD., 20 NORTH WACKER DRIVE, 36TH FLOOR, CHICAGO, IL, 60606, US

(21) Appl. No.: 11/193,589

(22) Filed: Jul. 29, 2005

(51) Int. Cl. E06B 9/30

(52) U.S. Cl. 160/168.1 R

(57) ABSTRACT

A window covering including a plurality of panels vertically suspended from a vertical securement member is provided. The plurality of panels is secured with the securement member about an upper transverse portion of the panels at spaced intervals along the securement member. The closure rows are convertible between different configurations by detaching the lower transverse portions of the closure rows from the suspension members.

### FIELD OF THE INVENTION

The present invention relates to the field of window coverings, and more particularly to window coverings including a plurality of panels.

### BACKGROUND OF THE INVENTION

Decorative window coverings are popular items for providing privacy and blocking light. These window coverings take on various forms, such as Roman shades, Venetian blinds, vertical blinds, honeycomb shades, and the like. Several of these window coverings include a panel or plurality of panels suspended from a head rail that cover an opening, which are connected to an adjustment mechanism with one or more control members.

For example, one popular type of window covering is known as a Roman shade. This type of shade consists of a fabric material attached along its top edge to a head rail and is gathered at spaced intervals to provide a series of soft folds across the face of the fabric. Consequently, the typical Roman shade has a cascaded or softly pleated appearance. An alternative to the conventional Roman shade is disclosed in co-pending application Ser. No. 10/427,829 filed on May 1, 2003, which is incorporated herein by reference. Unlike the standard Roman shade, the Roman style shade disclosed in co-pending application Ser. No. 10/427,829 enables the opening of the individual closure rows to create gaps in the face of the shade without requiring the entire shade to be raised.

Another common type of window covering is a Venetian blind. Venetian blinds are typically constructed of a plurality of slats that are supported by a pair of ladders, which are controlled by an adjustment mechanism in a head rail. The ladder typically includes a pair of parallel cords suspended from the head rail and connected to a bottom rail. A number of rungs span across the parallel cords and support the slats. An alternative to the conventional Venetian blind is disclosed in application Ser. No. 10/413,200 filed on Apr. 14, 2003, which issued as U.S. Pat. No. 6,792,996 on Sep. 21, 2004, and co-pending application Ser. No. 11/099,324 filed on Apr. 5, 2005, each of which is incorporated herein by reference. This Venetian type blind utilizes non-ladder control members and has a configuration that allows the slats to conceal the control members and holes for the control cords when the slats are closed.

Another alternative window covering is shown in co-pending patent application Ser. No. 11/099,249 filed on Apr. 5, 2005, which is hereby incorporated by reference. The window covering described therein includes a plurality of panels secured with a control member. The panels are suspended from the control member such that a lower longitudinal portion of the panels is allowed to hang freely. The panels preferably overlap one another such that when the window covering is closed there are no gaps between the panels. To open the window covering, a user pulls or retracts an opening member, which draws the lowermost panel upwards while the remaining panels remain in a resting position. The lowermost panel slides upwards behind an upper adjacent panel. By continuing to retract the opening member, the upper longitudinal portion of the lowermost panel contacts the upper longitudinal portion of the upper adjacent panel, and the lowermost panel and the upper adjacent panel are moved together behind the next upper adjacent panel. Each of the panels are rearwardly stacked in this manner as the opening member is retracted.

One shortcoming in the art is the lack of design flexibility in any one particular window covering. In other words, any one particular window covering can only have one appearance. As such, a user is unable to change a window covering without replacing the entire item. Similarly, a seller of window covering must carry multiple versions of window coverings in stock in order to accommodate different demands of customers.

It is desired to provide a window covering that may be customized or converted, either by the user or at the point of sale, to a variety of window covering designs. In so doing, stocks of window coverings that can be customized to different appearances can be ordered, rather than requiring inventories of many different types of window coverings. Also, a user can purchase one window covering, and if desired, change its appearance without having to remove and replace the entire window shade.

### SUMMARY OF THE INVENTION

The present invention provides a novel and improved window covering. The window covering includes a head rail, and a plurality of suspension members, such as securement and opening cords. The window covering includes a head rail that has one or more a control mechanisms, such as a cord lock, adapted to control raising and lowering of the suspension members. Some or all of the suspension members may be adjustably raised and lowered. A plurality of closure rows are suspended from the suspension members, and are secured at substantially evenly spaced intervals. Preferably, the closure rows are formed from a flexible material, such as a woven or non-woven fabric panel, woven mat of natural fibers, laminate, film, or the like.

Each of the closure rows defines an upper transverse portion and a lower transverse portion. For example, the upper transverse portion is the portion along the upper edge of the panel and the lower transverse portion is the portion along the lower edge of the panel. The upper transverse portion is secured with one of the suspension members. While the upper transverse portion may be fixedly secured with a suspension member, it is preferred that it be detachably secured. The lower transverse portion is also secured with another of the suspension members. The lower transverse portion is also detachably secured.

Any method or device for securing the relative portions of the closure rows to the suspension members may be utilized. However, it is preferred that the upper and the lower transverse portions are secured with the suspension members by a fastener module. Examples of suitable fastener modules are described in co-pending application Ser. No. 11/099,324 filed on Apr. 5, 2005, which is incorporated by reference. A fastener module may be detachably or fixedly secured to a suspension member. The fastener modules are also detachably securable with the transverse portions of the closure row. It is also preferred that the transverse portions of the closure rows include an anchor member to which the fastener module is secured. Use of an anchor member serves to lessen the stress on the material of the closure row itself, and tends to provide a more secure attachment. As discussed, the upper transverse portion is preferably, detachable from the suspension member, however, this is not necessarily required.

In order to convert the window covering from one configuration to another, transverse portions of the closure rows may be detached from the suspension members. For example, by detaching at least some of the lower transverse portions of the closure rows, a window covering can be converted from a first configuration, which is one type of window covering, to a second configuration, which is another type of window covering. The first configuration can be embodied in a number of ways, such as those described in the aforementioned co-pending application Ser. No. 10/427,829 and application Ser. No. 11/070,126. As discussed above, these configurations have Roman-style and Venetian blind-type appearances, respectively. If desired, a window covering with either of these configurations is transformed to the second configuration, which may be embodied as described in the aforementioned co-pending patent application Ser. No. 11/099,249.

In order to convert the window covering from a first configuration to a second configuration, a user detaches the lower transverse regions of at least some of the plurality of closure rows from their respective suspension members, such as by detaching the various fastener modules from the anchor members. The lower transverse regions are then unsupported and the panels hang freely from the upper transverse portions. In so doing, the appearance and operation of the window covering is changed without having to replace the window covering itself. Alternatively, it is also possible to detach the lower transverse regions of the plurality of closure rows and to reattached them at different locations on the suspension members to attain the second configuration.

As such, a user can, without the time expense of replacing a window covering, alter the aesthetics of a room. Similarly, a stock of window coverings can be set up at the point of sale in the desired configuration, thereby, reducing the amount of stock of window covering needed. These and other advantages of the present invention will be readily apparent to those of ordinary skill in the art.

### BRIEF DESCRIPTION OF THE DRAWINGS

In the drawings:

FIG. 1 is a perspective schematic front view of a preferred embodiment of the window covering of the present invention in a first configuration in a closed position;

FIG. 2 is a perspective schematic front view of the window covering of FIG. 1 in a partially opened position;

FIG. 3 is a partial perspective schematic rear view of the window covering of FIG. 1 in the closed position;

FIG. 4 is a side elevated cross sectional view of a closure row from the window covering of FIG. 1 in the second configuration;

FIG. 5 is perspective front view of the window covering of FIG. 1 in the second configuration in a fully closed position;

FIG. 6 is a perspective front view of the window covering of FIG. 5 in a partially open position;

FIG. 7 is a perspective front view of an alternative window covering according to a preferred embodiment of the present invention in the first configuration and closed position;

FIG. 8 is a perspective front view of the window covering of FIG. 7 in an open position;

FIG. 9 is an elevated cross sectional side view of the window covering of FIG. 7 in an open position; and

FIG. 10 is an elevated cross sectional side view of the window covering of FIG. 7 in the second configuration.

### DESCRIPTION OF THE PREFERRED EMBODIMENTS

The invention disclosed herein is, of course, susceptible of embodiment in many different forms. Shown in the drawings and described hereinbelow in detail are preferred embodiments of the invention. It is understood, however, that the present disclosure is an exemplification of the principles of the invention and does not limit the invention to the illustrated embodiments. For ease of description, the window covering embodying the present invention is described in its usual assembled position as shown in the accompanying drawings, and terms such as upper, lower, horizontal, longitudinal, etc., may be used herein with reference to this usual position.

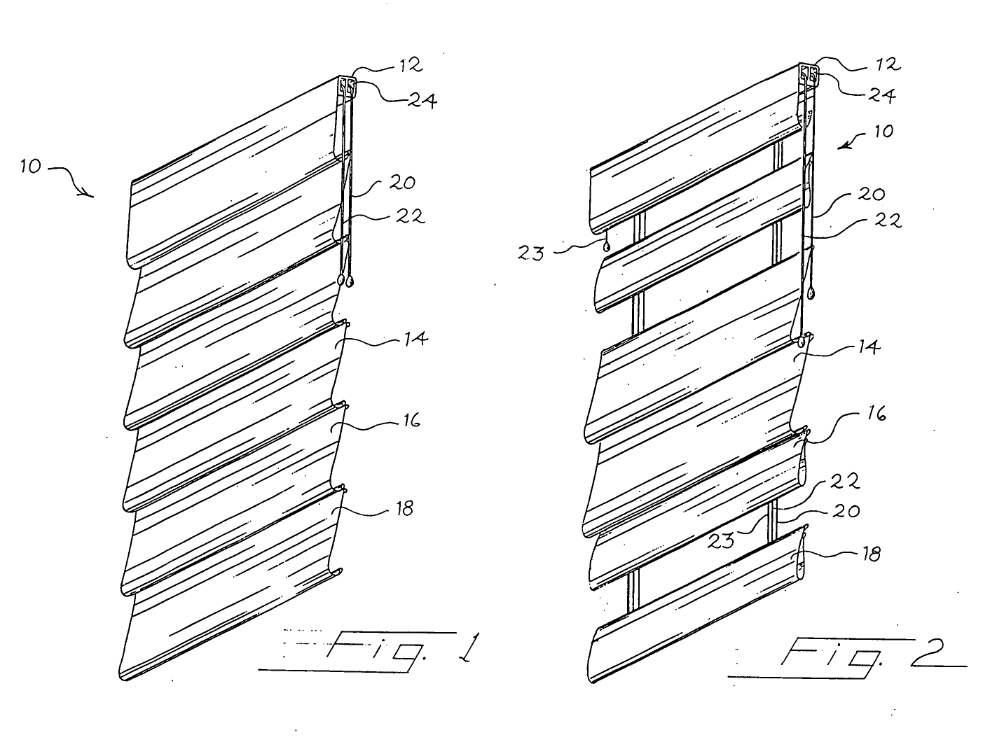

Referring to FIGS. 1 and 2, window covering 10 includes a head rail 12, and a plurality of closure rows, such as closure rows 14, 16, and 18. In the closed position shown in FIG. 1, the window covering 10 provides an appearance that is free of control cords or attachment members when viewed from the face of the window covering. In order to allow light to enter a room, various closure rows of the window covering 10 may be narrowed, such as shown in FIG. 2. Gaps are created between the closure rows by changing the relative distance between the upper and lower transverse portions of the closure rows. As shown, each of the closure rows 14, 16, and 18 are suspended from the head rail 12 by a plurality of suspension cords, such as control cords 20 and 22. A third control cord 23 is also included which is secured only to the lowermost closure row 18. Each of control cords 20, 22, and 23 are vertically adjustable, such as through use of cord lock 24 or other control mechanism in the head rail 12. Select closure rows, such as closure rows 16 and 18, can be narrowed while other closure rows, such as closure row 14, are not. This may be accomplished by selectively securing certain closure rows to the control cords. This process is described in co-pending application Ser. No. 11/099,324 discussed above.

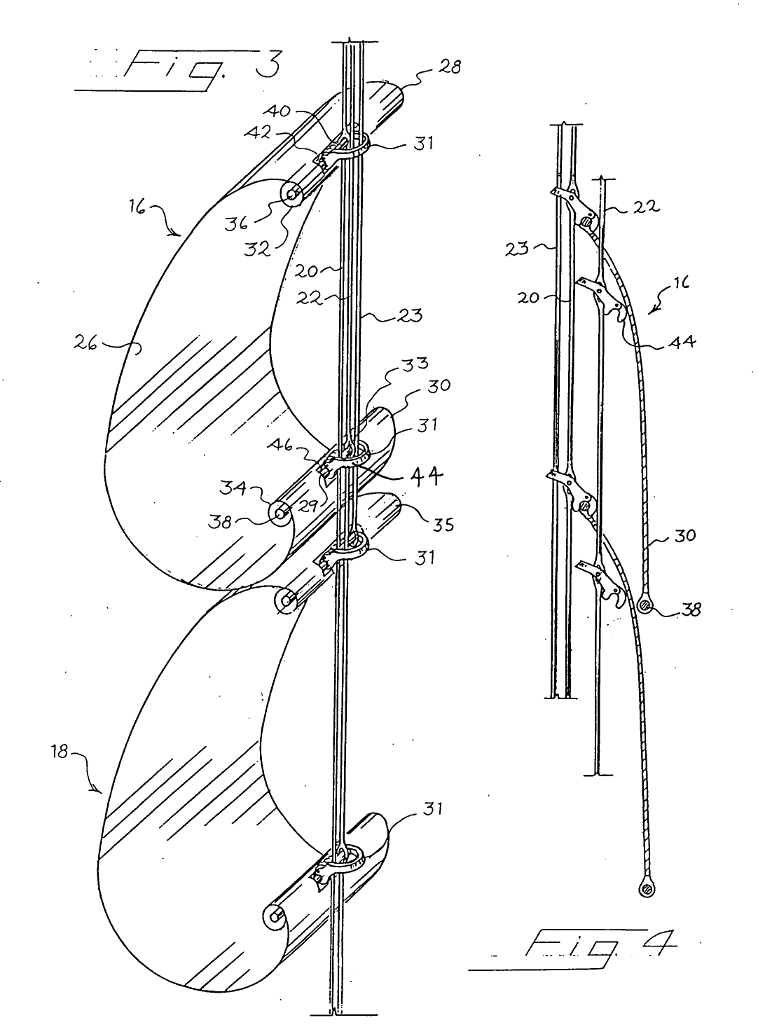

Referring to FIG. 3, an exemplary closure row 16 is discussed. Closure row 16 is formed of a panel 26 having an upper transverse region 28 and a lower transverse region 30. Each of the upper transverse region 28 and the lower transverse region 30 defines a loop, such as loops 32 and 34, through which anchor members 36 and 38, respectively, are passed. Anchor members 36 and 38 are preferably formed of a lightweight substantially rigid material, such as a plastic rod, lightweight wood dowel, or the like. Fastener module 40 is secured with control cord 20, and is also secured with upper transverse region 28 by grasping anchor member 36 through an aperture 42 in the upper transverse region 28. Another fastener module 44 is similarly secured to control cord 22, and is also secured with lower transverse region 30 by securement to anchor member 38 through an aperture 46 in the lower transverse region 30.

In this particular embodiment, the fastener modules are detachably secured with the suspension members, through loops formed in the suspension members. The fastener modules, however, may be fixedly secured or even integral with the suspension members, and may take many forms, such as disclosed in co-pending application Ser. No. 11/099,324. In this particular embodiment, the fastener module includes a clip member 29 that attaches to anchor member 38 and a buckle member 31 which is secured with a loop 33 in control cord 22. Although not shown, the suspension members may also include several loops that may be selectably utilized depending on the configurations of window coverings desired. In other words, the cord may include numerous loops, only some of which are used with a particular configuration of window covering. Other loops can be selected for different configurations of window coverings.

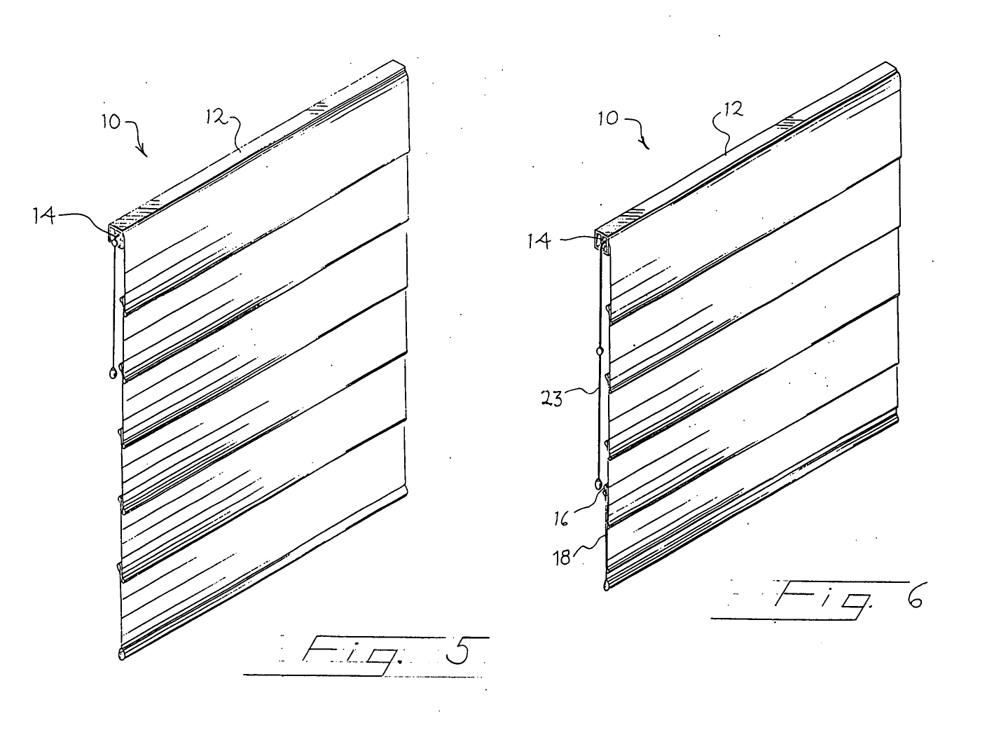

Each of the fastener modules is detachable from its respective anchor member. For example, fastener module 44 is detachable from anchor member 38 such that the lower transverse region 30 of closure row 16 is no longer secured to control cord 22. As shown in FIG. 4, when the lower transverse region 30 of closure row 16 is freed from the control cord 22, panel 26 is allowed to hang freely from control cord 20. By detaching the lower transverse regions of the various closure rows, the appearance of the window covering is converted from the first configuration to a second configuration, which is shown in FIG. 5. In this second configuration, rather than provide a window covering with billowed appearance, the window covering 10 presents a substantially linear look.

As discussed, it is preferred that the upper transverse portions of the closure rows are similarly detachably secured with control cord 20. In this way, entire closure rows may be removed from the window covering for cleaning, repair, or replacement.

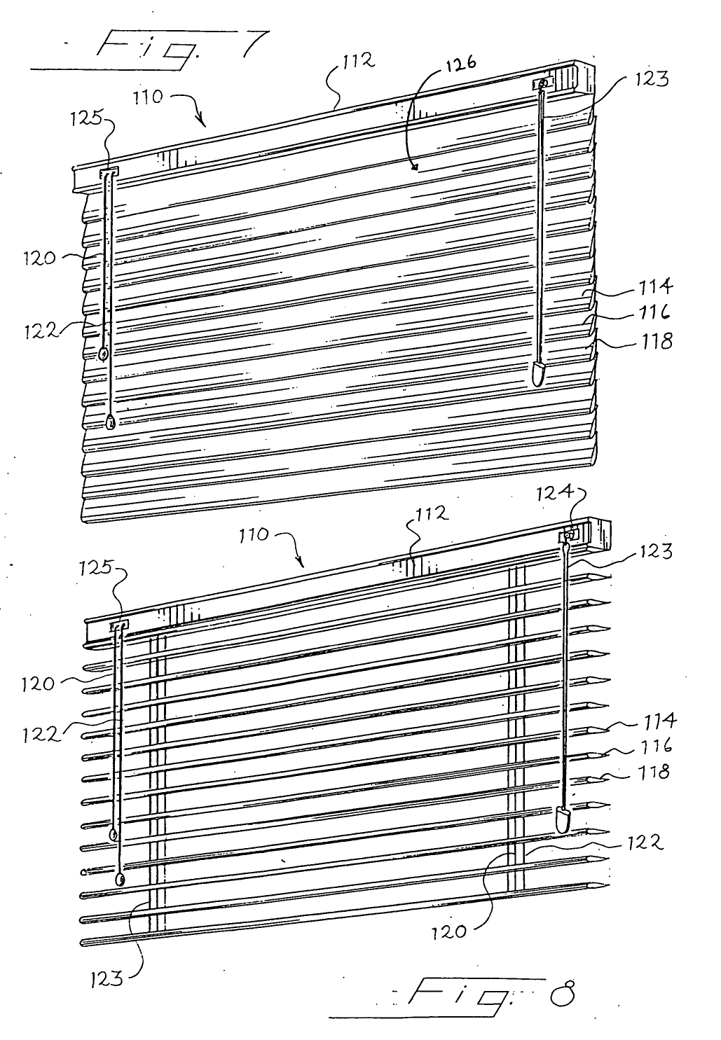

The operation of this example of a second configuration is discussed in detail in co-pending application Ser. No. 11/099,249. Briefly, another control cord, such as raising member 23 is secured only to the upper transverse portion 35 (FIG. 3) of the lowermost closure row 18. As raising member 23 is retracted, closure row 18 is drawn upwards behind closure row 16 until the upper transverse portion 35 of the lowermost closure row 18 contacts the upper transverse portion 28 of closure row 16. The various closure rows are stacked in this manner as shown in FIG. 6. The window covering 10 can be converted back to the first configuration by re-securing the lower transverse portions of the closure rows to the control cord 22.

Another preferred embodiment of the present invention is described in FIGS. 7-10. Referring to FIGS. 7 and 8, the window covering 110 provides a different first configuration from the previous embodiment. In the closed position shown in FIG. 7, a face side 126 of a Venetian blind type window covering 110 has an appearance free of cords or other components connecting the plurality of closure rows, which would otherwise disrupt the aesthetic appearance of the window covering. If it is desired to allow light into a room without raising the entire shade, a user can raise the appropriate control cord to rotate or tilt the closure rows to open as shown in FIG. 8.

Window covering 110 includes a head rail 112, and a plurality of closure rows, such as closure rows 114, 116, and 118, which are suspended from the head rail 112 by a plurality of suspension cords, such as control cords 120 and 122. A raising cord, such as cord 123 is also provided. Each of control cords 120, 122, and 123 are vertically adjustable, such as through use of cord locks 124 and 125, or other control mechanism in the head rail 112.

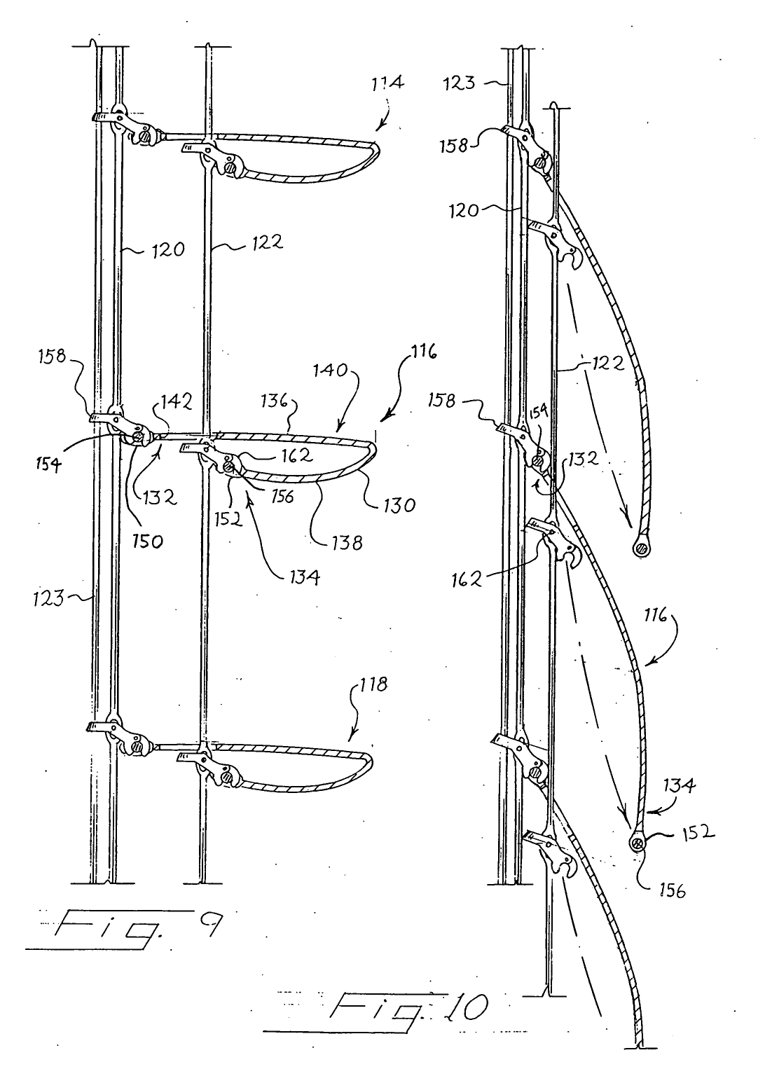

Referring to FIG. 9, each of the closure rows, such as for example closure row 116, includes a panel 130 which defines an upper transverse portion 132 and a lower transverse portion 134. Panel 130 is folded upon itself, forming a top region 136 and a bottom region 138. A distal edge region 140 extends distally from the control cord 122. The distal edge region 140 may be of a length that is greater than the distance between the adjacent closure rows such that when the window covering 110 is in the closed position the suspension members are concealed. The distal edge region 140 may alternatively be of a length equal to or even slightly less than the distance between adjacent closure rows. Raising cord 123 is not secured to any of the intermediate closure rows, such as closure rows 114, 116, and 118, but is secured to the upper transverse portion of a lowermost closure row (not shown).

Control cord 120 is secured to the upper transverse portion 132, and control cord 122 is secured to lower transverse portion 134. Control cord 122 passes through a hole 142. By raising or lowering the control cord 122, the closure row 116 is caused to rotate or tilt as desired. The relative positions of the top region 136 and the bottom region 138 are maintained by the weight of the panel 130. In other words, the gravitational force from the weight of the panel is counterbalanced by a lifting force applied to the panel 130 by the control cords. The operation of this embodiment is disclosed more fully in the aforementioned co-pending application Ser. No. 11/070,126.

As with the previous embodiment, each of the upper transverse portions, such as transverse portion 132 and the lower transverse portions, such as transverse portion 134, define loops, such as loops 150 and 152, respectively. Anchor members 154 and 156 are passed through loops 150 and 152. A fastener module, such as fastener module 158 is secured with control cord 120, and is also secured with upper transverse portion 132 by grasping anchor member 154. Fastener module 162 is similarly secured to control cord 122, and is also secured with lower transverse portion 134 by securement to anchor member 156.

It may also be desirable to stiffen or reinforce at least part of the distal edge region 140 to prevent sagging when in the open position. Stiffening can be accomplished through a number of methods, including by way of example the use of reinforcing strips, use of more fabric treatments, or directional weaving techniques.

Similar to the previous embodiment, the window covering 110 can be converted to a second configuration having free lower edges. In order to convert the window covering 110 from the first configuration to the second configuration, the lower transverse portion of the closure rows is detached from the suspension members in the manner described in the previous preferred embodiment. The panel thus hangs freely such as in FIG. 10. In this example, a region of panel 130 is stiffened, such that the panel 130 has a somewhat curved or non-linear profile.

In the embodiments discussed, the window coverings are described as being convertible only to a second configuration where the lower transverse portions of the closure row are detached from the suspension members. It should be understood, however, that other conversions are also possible. For example, as discussed above, the suspension members may include numerous loops or attachment points and in addition to detaching the lower transverse portion of a closure row, it may alternatively be repositioned. For example, the lower transverse portion of the closure rows of the Roman style shade described in FIGS. 1-3 may be repositioned as described in FIGS. 7-9 to form a Venetian-type blind. Accordingly, a single window covering may also be converted to any of the three configurations disclosed herein. In order to simplify such conversions, the suspension members may include color coded portions or other indicators to guide a user or seller of the proper attachment points for certain configurations.

The foregoing description and the accompanying drawings are illustrative of the present invention and not intended to be limiting. For example, it also be appreciated that in addition to the use of control cords, other suspension members, such as rear sheets or strips may be used. It should further be understood that while the use of fastener modules is preferred, in some embodiments it is not necessary. For example, an anchor member may be guided through a loop in a cord directly, and thereby secure its respective transverse portion to the suspension member. Still other variations and arrangements of parts are possible without departing from the spirit and scope of this invention.

We claim:

1. A window covering comprising:
a head rail;
a plurality of closure rows including a collapsible material suspended from the head rail, each of the closure rows having an upper transverse portion and a lower transverse portion;
a plurality of suspension members interconnecting the closure rows;
the upper transverse portion of the closure rows secured with at least one of the suspension members; and
the lower transverse portion of at least some of the closure rows detachably secured with the suspension members, wherein the window covering is convertible from a first configuration to a second configuration by at least detaching the lower transverse portion of at least one closure row such that the upper transverse portion remains secured to the at least one suspension member.

2. The window covering of claim 1, wherein the lower transverse portions of at least some of the closure rows are secured with the suspension member when in the first configuration, and are detached from the suspension member in the second configuration.

3. The window covering of claim 1, wherein the lower transverse portion of at least one of the closure rows is secured with one of the plurality of suspension members by a fastener module, the fastener module including a clip member suitable for securement with the lower transverse portion of the at least one closure row and a buckle member suitable for securement with the one of the plurality of suspension members.

4. The window covering of claim 3, wherein the lower transverse portion of the at least one closure row further includes an anchor member secured therewith and the clip member of the fastener module is securable with the anchor member.

5. The window covering of claim 3, wherein the at least one suspension member is a cord, and the fastener module is detachably secured to the cord.

6. The window covering of claim 1, wherein the upper transverse portion of at least one of the closure rows is detachably secured with one of the plurality of suspension members.

7. The window covering of claim 1, wherein the at least one suspension member is a cord comprising a plurality of loops, and the lower transverse portion of at least one closure row is operatively connectable with one of the plurality of loops.

8. The window covering of claim 1, wherein the lower transverse portions of the closure rows are secured with at least one of the suspension members at first attachment points when in the first configuration and are converted to the second configuration by detaching at least some of the lower transverse portions from the first attachment points and further converting the window covering to a third configuration by securing the lower transverse portions at second attachment points.

9. A window covering movable between a first configuration and a second configuration, the window covering comprising:
a head rail;
a plurality of suspension members operatively connected with the head rail, at least one of the suspension members being vertically adjustable;
a plurality of closure rows suspended from the suspension members;
each of the plurality of closure rows including an upper transverse portion and a lower transverse portion;
the lower transverse portions of the closure rows detachably secured with at least one of the suspension members; and
in the first configuration the upper transverse portion and the lower transverse portion of at least one closure row are secured with at least one suspension member, and in the second configuration the lower transverse portion of the at least one closure row is detached from the one or more suspension members.

10. The window covering of claim 9, wherein the lower transverse portion of at least one of the closure rows is detachably secured with at least one of the suspension members with a fastener module, and wherein the fastener module includes a clip member suitable for detachable securement with the lower transverse portion of the at least one closure row and a buckle member suitable for securement with the at least one suspension member.

11. The window covering of claim 10, wherein the at least one suspension member is a cord, and the fastener module is detachably secured to the cord.

12. The window covering of claim 9, wherein the at least one suspension member is a cord comprising a plurality of loops, and the lower transverse portion of at least one closure row is operatively connectable with one of the plurality of loops.

13. The window covering of claim 9, wherein the lower transverse portion of at least one of the closure rows includes an anchor member secured with at least one suspension member.

14. The window covering of claim 9, wherein the upper transverse portions of the closure rows are detachably secured with at least one of the suspension members.

15. The window covering of claim 9, wherein the lower transverse portions of at least one of the closure rows is secured with one suspension member at a first attachment point in the first configuration and is detached from the first attachment point and secured at a second attachment point to convert the at least one closure row to a third configuration.

16. The window covering of claim 9 further including a raising member secured with the upper transverse portion of a bottom closure row.

17. The window covering of claim 16, wherein adjustment of the raising member causes the bottom closure row to move relative to the intermediate closure rows.

18. A method for converting a window covering from a first configuration to a second configuration, the window covering including a head rail and a plurality of closure rows suspended from the head rail by a plurality of suspension members, and the method comprising:
detaching a lower transverse portion of at least one closure row from a first attachment point of at least one suspension member such that the closure row is secured with at least one suspension member by an upper transverse portion.

19. The method of claim 18 wherein detaching the lower transverse portion from the first attachment point comprises disengaging a fastener module secured with the suspension member from the lower transverse portion.

20. The method of claim 19 wherein disengaging a fastener module from the lower transverse portion including disengaging an anchor member restrainedly positioned with the lower transverse portion from the fastener module.

21. The method of claim 18 further comprising securing the lower transverse portion of the at least one closure row to a second attachment point of one of the plurality of suspension members.
